(19) United States
(12) Patent Application Publication
(10) Pub. No.: US 2014/0278859 A1
(43) Pub. Date: Sep. 18, 2014

(54) METHOD AND SYSTEM FOR SOCIAL NETWORK-ENHANCED ENDORSEMENT SERVICES

(71) Applicants: SCOTT DAVID GALLUCCI, MARTINEZ, CA (US); CLARK WARREN BRIGHAM, SANTA CRUZ, CA (US)

(72) Inventors: SCOTT DAVID GALLUCCI, MARTINEZ, CA (US); CLARK WARREN BRIGHAM, SANTA CRUZ, CA (US)

(21) Appl. No.: 13/797,878

(22) Filed: Mar. 12, 2013

(51) Int. Cl. G06Q 30/02

(52) U.S. Cl. CPC G06Q 30/0214
USPC 705/14.16

(57) ABSTRACT

A system and method that makes information available to participants of electronically mediated social networks that is provided by other parties is provided. The social network receives information about an entity, concept, vendor, service or good. A credentialed and authorized user of the associated account is enabled to both (a.) post this information and (b.) select rules that permit or deny access by other parties to the posted information according two or more alternative access permissions or permission profiles. The system enables informational posts to be made accessible to other social network accounts of that have been generally authorized a selected level of information access permission, such as a friend account status or a linked account status. A scope of search might be extended to a second or additional separation levels, such as friends of friends, or two or more degrees of linked connectivity.

### TECHNICAL FIELD

The present disclosure generally relates to the field of ecommerce and electronically mediated communications. More particularly, the present disclosure relates to accessing and applying electronically mediated social networking systems and assets in offering, receiving, reviewing and evaluating information and endorsements related to goods, services, vendors and service providers.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Advertising strategists and technologists are constantly innovating new techniques of reaching consumers and supporting the success of advertising clients in selling and marketing goods and services. Advertisements typically provide a call to action that is designed to motivate a consumer to take purchase or move closer to making a purchase. Quite often, advertising efforts include incentivizing the consumer to promptly purchase a product or service by publishing sale deadlines and offering coupons. Advertisers additionally apply prior art techniques to quantify the demographics of target audiences that will be addressed with specific advertisements, so that merchants can advertise to selected consumer groups to whom a merchant's products or services are more likely to be appealing or relevant.

More recently, the application in ecommerce of permission-based, location-specific push-service coupon messaging, such as provided by GROUPON™ couponing service, has experienced explosive growth. These Internet-based prior art techniques apply additional refinements to emailed and web-based advertising, such as the ability to associate merchants with particular geographies, in the hope that a proximity indicated by the advertising client might have a meaningful correlation with an increased likelihood of interest in by addressees and recipients of messages featuring “local” advertisers of goods and services.

Yet the challenge of gaining consumer attention by electronic commercial promotion grows in difficulty as prior art Internet-enabled couponing and advertising campaigns grow in frequency and intensity. In particular, potential purchasers often feel inundated and overwhelmed with promotional messages that masquerade as recommendations and endorsements, when in fact many of these Internet-based coupon services are essentially advertising services that differ little in perceived value to addresses and targeted consumers from prior art mass marketing campaigns. There is therefore a long-felt need to increase the likelihood that information about a service, good, or vendor is accurate, relevant and actionable to a consumer to whom the information as made available or provided. There is also a long-felt need to increase a consumer's confidence in information related to purchasing decisions.

### SUMMARY AND OBJECTS OF THE INVENTION

Towards these objects and other objects made obvious in light of the present disclosure, a dynamic system and method is disclosed herein that makes information available to participants of electronically mediated social networks that is provided by selected, known, trusted and/or identifiable parties. In certain preferred embodiments of the method of the invention (“the invented method”), an Internet-enabled social network receives information about an entity, vendor, service, good or concept that associated with an account of the social network. A credentialed and authorized user of the associated account is enabled to both (a.) post this information and (b.) select rules that permit or deny access by other parties to the posted information according two or more alternative access permissions or permission profiles. The system optionally and/or alternatively enables informational posts to be made accessible to other accounts of the same or other alternate social network that have been generally authorized a selected level of information access permission, such as a friend account status or a linked account status. Still alternately or additionally, a scope of search might be extended to a second or additional separation levels, such as friends of friends, or two or more degrees of linked connectivity.

Additionally or optionally, a posting account or party may direct the hosting social network service to associate various information into themed lists and/or associated groups. Access to one or more of these lists and groups may optionally be limited or permitted to particular parties or levels of defined or specified relationship permissions of the social network. The posted information provided may include special pricing and coupon offers.

Thus, the invented system and method provides users with information concerning identified entities, concepts, merchants, goods, services, and leases that is associated with a posting source that is identifiable to at least some degree by the user, thereby enhancing the context within which the posted information is presented or accessed by an enquirer or potential enquirer, consumer, purchaser or licensee of a good or service.

The invented system and method further provide an optional aspect that generates a relevance and/or quality level indicator based upon the selected factors, to include geographic proximity, timeliness, trust level of information providers, relationship status of information providers, and quality indications provided with or within the information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

These, and further features of the invention, may be better understood with reference to the accompanying specification and drawings depicting the preferred embodiment, in which:

FIG. 1 is a schematic of an electronic communications network that supports a social network and includes participant systems, an exemplary client system and one or more service providing systems;

FIG. 2 is a representation of software modules of a client system or a participant system of the electronic communications network of FIG. 1;

FIG. 3 is a representation of additional software modules of a social network service providing system of the electronic communications network of FIG. 1 and including an exemplary first account record;

FIG. 4 is a block diagram of a representative referral record of the electronic communications network of FIG. 1;

FIG. 5 is a flowchart of a generation of a referral record that is executable by the client system and/or a participant system of FIG. 1, and/or by interaction with the social network service providing system of the electronic communications network of FIG. 1;

FIG. 6 is a flowchart of an execution of a search query as executable by the electronic communications network of FIG. 1;

FIG. 7 is a flowchart of an optional generation of ranking value of one or more referral records of FIG. 4 as selected in an execution of the search process of FIG. 6;

FIG. 8 is a block diagram of additional optional aspects of the exemplary account record of FIG. 3;

FIG. 9 is a block diagram of a business record that comprises a plurality of referral records of FIG. 4 that relate to a same business entity;

FIG. 10 is a block diagram of a search request, or query message, issued by an authorized or credentialed user of an account of the service provider of FIG. 1;

FIG. 11 is a process chart of additional aspects of the invented method in processing queries within the social network of FIG. 16;

FIG. 12 is a flow chart of a generation of the first query message of;

FIG. 13 is a flow chart of the actions of the service provider in responding to the first query message of FIG. 10;

FIG. 14 is a block diagram of a query response message generated by the server in execution of the flow chart of FIG. 13;

FIG. 15 is block diagram of aspects of the server that support maintenance and generation of the social network of FIGS. 1, 2 and 3; and

FIG. 16 is an entity diagram of the social network as generated and maintained by the service provider and electronic communications network of FIG. 1.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

FIG. 1 is a schematic illustration of an electronic communications network 2 that bi-directionally communicatively couples an comprises a social network web service provider 4 with a plurality of participant systems 6, wherein a client system 8 is an exemplary participant system 8 that is designated as client system 8 for the sake of clarity of explanation of the interaction of the participant system 6 & 8 with the network 2. The electronic communication network 2, or “network” 2, includes the Internet 2A and one or more telephony networks 2B. The social network web service provider 4, or “service provider” 4, includes a network system software SW4.1 and a social networking platform software SW4.2, wherein the network system software SW4.1 enables the service provider 4 to perform the aspects of the invented method as disclosed herein in interaction with the participant system 6 and the network 2 as identified herein.

It is understood that the service provider 4 may alternately or additionally be embodied or instantiated by a plurality of web servers 10 and elements of the social networking platform software SW4.2 that are distributed throughout the network 2. For example, the service provider 4 may be comprised within a social networking web service, such as a FACEBOOK™ or LINKEDIN™. The social networking platform software SW4.2, or “platform” SW4.2, may be, or include, be communicatively integrated with, or be comprised within a commercially available or proprietary social networking software, such as TWITTER™ or PINTEREST™.

Each participant system 6, to include the client system 8, includes a user software SW6.1 that enables the hosting participant system 6 to participate in an electronically mediated social network SN enabled by the platform SW4.2. For the sake of clarity of explanation, the user software SW6.1 and enabling software and instructions hosted by, accessible to and/or applied by the client system 8 will be designated hereinafter as “the client software CSW”.

The service provider 4 and additional web servers 8 & 10 maintain a plurality of accounts ACCT.001-ACCT.N comprised with the social network SN. The service provider 4 and additional web servers 8 & 10 may be or comprise one or more a network-communications enabled THINKSTATION WORKSTATION™ notebook computer marketed by Lenovo, Inc. of Morrisville, N.C.; WA; or other suitable web server enabled or suitable information processing technology known in the art.

It is understood that it is preferable that each the client system 8 and each participant system 6 comprise a geolocational module 602 that indicates a current location of the hosting system 8 & 6, such as a global positioning system receiver that determines a location of the hosting client system 8 and/or each participant system 6 through reception of radio signals generated by satellites of the Global Positioning System (“GPS”). GPS is the satellite-based navigation system made up of a network of 24 satellites placed into Earth orbit by the U.S. Department of Defense.

One or more participant systems 6 & 8 may be or comprise (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable computational system or electronic communications device known in the art capable of providing or enabling an information technology communications process.

Referring now to FIG. 2, FIG. 2 is a block diagram of components of the client software CSW that are also preferably included within the user software SW.6. A communications interface CSW.IF enables the hosting client system 8 or participant system 6 to interact with the social network SN maintained by the service provider 4 & web servers 10. A client graphical user interface module CSW.GUI, or “client GUI”, provides a graphical user interface on the client system 8 that posts information from, and accepts inputs to, the social network SN. A relationship list module CSW.REL enables a member assigned an account ACCT.001-ACCT.N with the social network SN, or having access to a account ACCT.001-ACCT.N of the social network SN to direct the social network SN to accept, configure, maintain and enforce levels of relationship status qualities of the accessed account ACCT.001-ACCT.N with other accounts ACCT.001-ACCT.N of the social network SN. A client evaluation module CSW.EVAL enables a member of the social network SN to direct the social network SN to create, configure and maintain a referral record R.REC.001-R.REC.N specifying an entity, e.g., a business, a retail business or a professional services provider, and accept information to enter into one or more referral records R.REC.001-R.REC.N. The client evaluation module CSW.EVAL and/or the service provider 4 maintains an endorsement list ELIST-001-ELIST.N within an account ACCT.001-ACCT.N comprising one or more referral records R.REC.01-R.REC.N created or generated by a same account ACCT.001-ACCT.N.

An account record module CSW.ACCT maintains local copies of account information of a selected account ACCT.001-ACCT.N. An optional default query location marker CSW.LOC stores a default geographic location coordinate data that may be applied to queries associated with a account ACCT.001-ACCT.N sent out from the client software CSW to the social network SN or network 2. An update module SN.UPD of the social network SN enables a credentialed user of any account ACCT.001-ACCT.N to access, apply and update the components of the account ACCT.001-ACCT.N that is authorized for access to the user by the social network SN to add, delete, modify and update referral records R.REC.001-R.REC.N and account relationship status selections.

FIG. 3 is a block diagram of components of the platform SW4.2 and an exemplary first account ACCT.001. The exemplary first account ACCT.001 enables a user, upon presenting sufficient credentials to the social network SN, to access the exemplary first account ACCT.001 and to interact and engage with other accounts ACCT.002-ACCT.N of the social network SN.

The platform SW4.2 maintains a plurality of accounts ACCT.001-ACCT.N that each preferably maintain both history data and user interaction data that have been harvested from a use of a particular account ACCT.001-ACCT.N with the social network SN. Each account ACCT.001-ACCT.N, as shown by the exemplary first account ACCT.001 of FIG. 3, maintains a relationship listing module REL.MOD that identifies other accounts ACCT.002-ACCT.N and specifies relationship levels between each account ACCT.002-ACCT.N identified by or within the exemplary first account ACCT.001. A referral record module EVAL.MOD of the social network SN enables a user to generate referral records R.REC.001-R.REC.N that include information provided through the user interaction of the exemplary first account ACCT.001 as enabled by the social network SN. Each referral records R.REC.001-R.REC.N is preferably related to an identified entity. An account history module HIST.MOD maintains history data and user interaction data, e.g., search queries, recorded and related to the exemplary account ACCT.001 by the social network SN. It is understood that each additional account ACCT.002-ACCT.N preferable has a personalized version REL.MOD, EVAL.MOD & HIST.MOD of the components of the exemplary first account ACCT.001.

A logic and rules module SN.LOG of the social network SN interprets information and designations of accounts ACCT.001-ACCT.N. In one exemplary embodiment, offered for the purposes of illustration and clarification and not limiting the scope of the disclosure, logic and rules module SN.LOG is configured to enforce a relationship status, e.g., a status of FRIEND or FOLLOWING within an exemplary social network, such as respectively FACEBOOK™ or TWITTER™.

An account update module SN.UPD enables the platform SW4.2 of the service provider 4 & 10 to generate and service the social network SN and communicate with the participant systems 6 & 8.

Referring now to FIG. 4, FIG. 4 is an illustration of an exemplary first referral record R.REC.001 that is originated and at least partly populated through the interaction with and input of the exemplary first account ACCT.001 and the social network SN. The exemplary first referral record R.REC.001 includes a record identifier R.REC.ID that uniquely identifies the first referral record R.REC.001 to the service provider 4 & 10, an account identifier ACCT.ID that identifies the originating first account ACCT.001 by which the comprising referral record R.REC.001 is initiated and provided, an entity identifier ENTITY.ID that identifies a vendor, service provider or other entity, an access level marker ACCESS.MRK, a time date stamp TDS, an entity location coordinate date ENTITY.LOC, and an information data field INFO.DATA that comprises one or more evaluation information INFO.EV concerning the entity referenced by the an entity identifier ENTITY.ID of the comprising referral record R.REC.001. The evaluation information INFO.EV is preferably input via an account ACCT.001-ACCT.N that originates the first referral record R.REC.001 and the access level marker ACCESS.MRK indicates any attributes required by any other account ACCT.001-ACCT.N that the social network rules SN.LOG would require in order to enable access to the first referral record R.REC.001, e.g., a requirement that an account ACCT.001-ACCT.N requesting access to the first referral record R.REC.001 have a status of FRIEND or FOLLOWING in relationship to the account ACCT.001-ACCT.N that originated the first referral record R.REC.001. Extending degrees of separation within a social network status might also be indicated by the access level marker ACCESS.MRK, such as second degree separation status within the social network, e.g., an account ACCT.001-ACCT.N having a relatedness status of FRIEND of an intervening account ACCT.001-ACCT.N, wherein the intervening account ACCT.001-ACCT.N has a relatedness status of a FRIEND to the account ACCT.001 that originated the first referral record R.REC.001. The intervening account ACCT.001-ACCT.N might be designated as having a secondary relatedness status FRIEND OF A FRIEND.

The time date stamp TDS provides information indicating the freshness of the information provided in the evaluation information INFO.DATA & INFO.EV.001-INFO.EV.N. The evaluation information INFO.DATA & INFO.EV.001-INFO.EV.N. may comprise different qualitative and quantitative types of information. For example, the a general evaluation information INFO.DATA might be a simple textual input and have no associated quantitative score. A first quality evaluation score INFO.EV.001 might record a numerical valuation of a global evaluation of the entity associated with the entity identifier ENTITY.ID (hereinafter, “named entity”). A second evaluation score INFO.EV.002 might be a numerical rating of a particular quality of the named entity, such as the pricing of goods or serviced offered by the named entity. An Nth evaluation score INFO.EV.N might be a numerical rating of an Nth specified quality of the named entity, such as an evaluation of a level of expertise of employees of the named entity.

FIG. 5 is a flowchart of the operation of the service provider 4 in interaction with a participant system 6 & 8 in the generation of the exemplary first referral record R.REC.001 and/or modification of an existing referral record R.REC.002-R.REC.N. In step 502 the service provider 4 determines if a request has been received from a participant system 6 & 8 to form a first exemplary referral record R.REC.001, and if no record generation request is detected in step 502, the service provider 4 proceeds on to step 504 and to determine if a request to access to or modify a previously generated referral record R.REC.002-R.REC.N has been received. When the service provider 4 determines in step 504 that no request to access to or modify a previously generated referral record R.REC.001 has been received, the service provider 4 proceeds on to step 506 and to perform alternate computational operations. It is understood that the service provider 4 may proceed from step 506 to step 502 as directed by inputs to or processes of the service provider 4 or as initiated by a participant system 6 & 8. In the alternative, when the service provider 4 determines in step 504 that a request to access to or modify a previously generated referral record R.REC.002-R.REC.N has been received, the service provider 4 selects and opens the requested referral record R.REC.002-R.REC.N in step 508 and proceeds on from step 508 to the execute the logic of steps 512 through 522 regarding the referral record R.REC.002-R.REC.N selected in step 504.

When the service provider 4 determines in step 502 that a request has been received from a participant system 6 & 8 to form a first exemplary referral record R.REC.001, the service provider 4 proceeds on to step 510 and creates the exemplary first referral record R.REC.001 and populates the first referral record R.REC.001 with a record identifier R.REC.ID and an account identifier ACCT.ID, wherein the ACCT.ID as provided by the participant system 6 & 8 in communication with the service provider 4 and in requesting the current process of FIG. 5.

The service provider 4 next populates the selected referral record R.REC.002-R.REC.N of step 504 or the newly generated first referral record R.REC.002-R.REC.N of step 502 with updated or initial information accepted or generated in these steps: in step 512 the service provider 4 accepts an entity identifier ENTITY.ID and determines an associated geographic location ENTITY.LOC; in step 514 the service provider accepts and/or modifies an access permission level marker ACCESS.MRK; in step 516 the service provider accepts evaluation text and/or image data for storage in information data fields INFO.DATA; and in optional step 518 the service provider accepts and/or generates one or more quantitative ranking values INFO.EV.001-INFO.EV.N of the entity identified in step 512.

The service provider 4 generates a time/date stamp TDS in step 520 of the time of completion of step 520 and writes this original or revised time/date stamp TDS into the instant R.REC.001-R.REC.N in that same step. The service provider 4 proceeds from step 5.20 to close the instant R.REC.001-R.REC.N in step 522 and thereupon to step 506 to perform alternate computational operations.

It is understood that the client system 8 or a participant system 6 may additionally or alternatively execute the logic of FIG. 5 to generate or update a referral record R.REC.001-R.REC.N and thereupon transmit the created or revised referral record R.REC.001-R.REC.N to the service provider 4, the social network SN, and/or other participant system 6.

FIG. 6 is a flowchart of the operation of the service provider 4 in interaction with a participant system 6 & 8 in the execution of a query. In step 602 the service provider 4 determines whether a search query has been received, and when the service provider 4 determines that a search query has not been received, the service provider proceeds on to step 604 and to perform alternate computational operations. In the alternative, when the service provider 4 determines that a search query had been received in step 602, the service provider proceeds on to step 606 and accepts the query, and thereupon in step 608 scales the scope of a search based upon the limitations of the query. Limitations of scope might include (a.) geographic distance of an entity from a location provided in the query or a default geographic location associated with an account of the social network SN; (b.) referral records R.REC.001-R.REC.N that are listed as being generated by accounts having a FRIEND status or a LINKED status with the account initiating the query; (c.) referral records R.REC.001-R.REC.N that are listed as being generated by accounts having a FRIEND OF A FRIEND status or an extended LINKED status with the account initiating the query; (d.) referral records R.REC.001-R.REC.N having certain key words provided in the query; (e.) referral records R.REC.001-R.REC.N having evaluation rankings above a certain level; and/or (f.) referral records R.REC.001-R.REC.N having a most recent time date stamp data TDS no later than a default temporal separation from the receipt of the current query and/or a specified time and date as provided in the current query.

The service provider performs a search of the databases of the social network SN in step 610 and optionally calculates ranking scores of one or more referral records R.REC.001-R.REC.N in step 612. The service provider 4 then formats a search report in step 614 and renders or transmits the search report to the client system 8 in step 616. The service provider 4 then determines if another query is pending or received in step 618, and proceeds on to repeat an execution of the logic of steps 606 through 618 when another pending query is detected during the current execution of step 618. When the service provider 4 determines in step 618 that no other query is pending or received in the current execution of step 618, the service provider proceeds on to step 604 and to perform alternate computational processes. It is understood that the service provider 4 may proceed from step 604 to step 602 as directed by received inputs or by processes of the service provider 4 or as initiated by a participant system 6 & 8.

FIG. 7 is a flowchart of an optional calculation of a ranking score of a referral record R.REC.001-R.REC.N as referred to in step 6.12 of the process of FIG. 6. In step 702 the service provider 4 accesses the query search results in accordance with the invented method. In step 704 the service provider selects a first record R.REC.001 or a yet unexamined record R.REC.002-R.REC.N of the search results of step 702. The service provider 4 calculates a ranking R of the most recently selected referral record R.REC.001-R.REC.N in step 706, wherein a ranking algorithm applied in step 706 may integrate one or more values of (a.) a ranking value V of the selected referral record R.REC.001-R.REC.N; (b.) a degree of relationship status indicator REL describing a relationship distance determined between the social network account ACCT.ID of the selected referral record R.REC.001-R.REC.N and the social network account that initiated the query; (c.) the most recent time date stamp data TDS of the selected referral record R.REC.001-R.REC.N; and/or (d.) a measure of geographic or travel distance or difficulty determined between the entity location ENTITY.LOC and a location either provided in a query of step 602 or step 618, or a default location of the social network account that initiated the instant query.

The service provider 4 next normalizes the results of the most recent execution of step 708 with any results of any previous evaluations of the search results of step 702, and determines in step 710 if any search results of step 702 remain unexamined and unranked. When the service provider 4 determines in step 710 that at least one referral record R.REC.001-R.REC.N of the search results of step 702 remain unexamined and unranked, the service provider processes an additional and unexamined referral record R.REC.001-R.REC.N of the search results of step 702 by an additional execution of the logic of steps 704 through 710.

Alternatively, when the service provider 4 determines in step 710 that no referral records R.REC.001-R.REC.N of the search results of step 702 remain unexamined and unranked, the service provider proceeds on to step 712 and to report that rankings to the client system 8 in step 712, and thereupon to return to step 618 of the process of FIG. 6.

It is understood that the client system 8 may additionally or alternatively execute the logic of FIG. 7 to produce and report rankings of search results to a user.

FIG. 8 is a block diagram of additional optional aspects of the exemplary first account ACCT.001 as maintained by the service provider 4. The first account ACCT.001 includes an account identifier ACCT.ID that uniquely identifies the first account to the service provider 4 and the social network SN; a reported or default location ACCT.LOC that is applied in determining distances between a user and entities and businesses in application of the invented method; a first region identifier REG.ID.001 that indicates a region REG.001-REG.N of the social network SN with which the first account ACCT.001 is primarily associated; a plurality of weighting factors W1.ACCT-WN.ACCTN that may be applied in calculating rankings of referral records R.REC.001-R.REC.N; a first listing of additional accounts 1ACCT.CON1-ACCT.CON1 to which the instant first account ACCT.001 relates to as presenting one degree of separation from the first account ACCT.001, e.g., accounts having the status of FRIEND as applied by the social network generated by FACEBOOK™ social network service; a second listing of additional accounts 1ACCT.CON2-ACCT.CON2 to which the instant first account ACCT.001 relates to as presenting two degrees of separation from the first account ACCT.001, e.g., accounts having the status of FRIEND with an account ACCT.002-ACCT.N with which the first account ACCT.001 maintains in the relatedness status of FRIEND, or “friend of a friend” as applied by the social network generated by FACEBOOK™ social network service.

The first account ACCT.001 optionally include a first endorsement list ELIST.001 of a plurality of referral records R.REC.001-R.REC.N that the first account ACCT as the originating account of the included referral record.

FIG. 9 is a block diagram of an exemplary first business record BUS.REC.001 that comprises a plurality of referral records R.REC.001-R.REC.N of FIG. 4 that relate to a same business entity. The first business record BUS.REC.001 includes a business record identifier BUS.REC.001 that uniquely identifies the first business record BUS.REC.001 to the social network SN; a first business identifier BUS.ID.001 that uniquely identifies an entity, e.g., a business, a venue, or an association that is associated with the business record identifier BUS.REC.001 by the social network SN; and a first business type identifier BUS.TYPE.001 that associates the comprising first business record BUS.REC.001 with a type of business. It is understood that certain business records BUS.REC.001-BUS.REC.N may includes two or more business type identifiers BUS.TYPE.001-BUS.TYPE.N as certain entities provide more than one category of good and service, e.g., consider a retail grocery that includes a pharmacy.

The first business record BUS.REC.001 preferably includes or is associated with a plurality of referral records R.REC.001-R.REC.N that present the first business identifier BUS.ID.001 as the instant listed entity identifier ENTITY.ID and/or relate the first business identifier BUS.ID.001 as the listed entity identifier ENTITY.ID included in each referral record R.REC.001-R.REC.N.

FIG. 10 is a block diagram of an exemplary first query message Q.MSG.001 issued by an authorized or credentialed user of the first exemplary account ACCT.001 of the social network SN. The first query message Q.MSG.001 includes a query first message identifier Q.MSG.ID.001 that uniquely identifies the instant first query message Q.MSG.001; an account identifier ACCT.ID.001 that identifies the first account ACCT.001 as the originator of the instant first query message Q.MSG.001; a business type identifier BUS.TYPE that identifies what type of business the instant first query message Q.MSG.001 is intended by the user to address; a user location USER.LOC that presents a location which the social network SN shall use to determine distance and location relevance in responding to the first query message Q.MSG.001; and optional distance limit DIST.LIMIT that directs the social network SN in responding to the instant first query message Q.MSG.001, to consider referral records R.REC.001-R.REC.N that indicate a business location BUS.LOC calculated by the service provider 4 to be within the specified distance limit DIST/LIMIT from the user location USER/LOC. The first query message Q.MSG.001 may optionally further include parameter weighting factors W1-WN that may be applied in by the social network SN in calculating rankings of referral records R.REC.001-R.REC.N in responding to the instant first query message Q.MSG.001; a time-date limit TDS.LIMIT that directs the social network SN to not consider referral records R.REC.001-R.REC.N indicating a time of generation later that the time-date limit TDS.LIMIT; and a connectivity limitation CONN.X that indicates any limitation or preference requirement based one the existence of a special relationship status of an originator of a referral record R.REC.001 in relation to the originator account ACCT.001 of the instant first query Q.MSG.001 to be applied by the social network SN in ranking referral records R.REC.001-R.REC.N in responding to the instant first query Q.MSG.001.

Referring now generally to the Figures and particularly to FIG. 11, FIG. 11 is a process chart of additional aspects of the invented method. In step 1102 an account user applies the client system 8 to generate the first query message Q.MSG.001 and transmit the first Q.MSG.001 to the service provider 4. The client system 8 may include a value of the user location USER.LOC that is or includes (a.) a default user location CSW.LOC; (b.) a GPS value generated by the client system 8; (c.) a geolocational value provided to or generated by the client system 8 by suitable means and methods known in the art. The account user may further optionally specify specific values, or the client system 8 may populate the first query message Q.MSG.001 with default values associated with the first account ACCT.ID, for one or more of the parameters of (a.) weighting factors W1-WN, (b.) distance limitation DIST.LIMIT; (c.) time-date limitation TDS.LIMIT, and/or (d.) connectivity status limitation CONN.X.

The service provider 4 selects the user location in step 1104 from either (a.) the first query message Q.MSG.001 or (b.) the applies first account default user location CSW.LOC when the first query message Q.MSG.001 fails to supply a user location USER.LOC. The service provider 4 next finds business records BUS.REC.001-BUS.REC.N that indicate (a.) the business type BUS.TYPE.001 of the first query message Q.MSG.001, and (b.) an entity location within the distance limitation DIST.LIMIT, or alternately within a default distance limitation, from the (i.) user location USER.LOC.001 of the first query message Q.MSG.001 or (ii.) the default user location CSW.LOC. The service provider in step 1108 then selects referral records R.REC.001-R.REC.N from the business records BUS.REC.001-BUS.REC.N selected in step 1106, optionally in order of indicated connectivity of an originator of each referral record R.REC.001-R.REC.N with the first account ACCT.001, i.e., the originating account of a query message Q.MSG.001-Q.MSG.N.

In step 1110 the service provider 4 applies a ranking algorithm to the referral records R.REC.001-R.REC.N harvested in step 1108. The referral ranking algorithm may applies vary parametric weighting factors W1-W4 or W.ACCT-W.ACCT.N to various aspects of the referral records R.REC.001-R.REC.N, these referral aspects potentially including, but limited to, (a.) proximity of an entity location BUS.LOC.001-BUS.LOC.N to the user location USER.LOC of the first query message Q.MSG.001; (b.) number of referral records R.REC.001-R.REC.N of a same business record BUS.REC.001-BUS.REC.N that are originated by an account ACCT.002-ACCT.N that is identified by the social network SN as having a level of connectivity CON1-CON2 with the first query message Q.MSG.001 equal to or closer than a specified connectivity level CONN.X of the first query message Q.MSG.001; and (c.) number of referral records R.REC.001-R.REC.N of a same business record BUS.REC.001-BUS.REC.N that are originated by an account ACCT.002-ACCT.N that is identified as being in a same region REG.ID.001 as the originating account ACCT.001 of the first query message Q.MSG.001. It is understood that the parametric weighting factors W1-W4 as supplied within the first query message or the default parametric weighting factors W.ACCT-W.ACCT.N of the first account ACCT.001 may alternately applied by the service provider 4 in step 1114.

Optionally and additionally, the service provider 4 may in step 1116 collate and rank referral records R.REC.001-R.REC.N originated by account ACCT.001-ACCT.N that are not associated with a same region REGION A-REGION N as the first account ACCT.001, i.e., with the account ACCT.001-ACCT.N originating an instant query message Q.MSG.001-Q.MSG.N.

The service provider 4 generates and transmits a first query response Q.RESP.001 in step 118 to the client system 8 and the social network SN determines in step 1120 whether to return to process another query message Q.MSG.002-Q.MSG in another instantiation of step 1102, or to proceed on to perform alternate operations of step 1122.

FIG. 12 is a flow chart of a generation of the first query message Q.MSG.001 by the client system 8 or other participant system 6. The first query message Q.MSG.001 will be referenced in the following discussion of FIG. 12 as a clarifying example and not as indicating any limitations. In step 12.02 the user initiates the new first query message Q.MSG.001 and proceeds on to step 12.04 to provide the client software CSW with a business type BUS.TYPE of interest, and thereupon in steps 12.06 through 12.16 optionally provide key data, such as user location USER.LOC and weighting factors limitation W1-WN, and certain limitations of the desired search, including the connectivity limitation CONN.X, the time limitation TIME.LIMIT, and the distance limitation DIST.LIMIT. In step 12.18 the user submits the first query message Q.MSG.001 to the social network SN by transmission of first query message Q.MSG.001 to the service provider 4. The client system 8 determines in step 12.20 whether a response message RESP.MSG.001-RESP.MSG.N corresponding to the first query message Q.MSG.001 has been received. When the client system 4 determines in step 12.20 that a response message RESP.MSG.001-RESP.MSG.N corresponding to the first query message Q.MSG.001 has been received, the client system 8 proceeds on to step 12.22 and to render the received response message RESP.MSG.001-RESP.MSG.N. The client system 8 proceeds from step 12.22 or step 12.02 to perform alternate computational operations.

FIG. 13 is a flow chart of the actions of the service provider 4 in responding to the first query message Q.MSG.001. The first query message Q.MSG.001 and a corresponding first response message RESP.MSG.001 will be referenced in the following discussion of FIG. 13 as a clarifying examples and not as indicating any limitations.

The service provider 4 receives and accepts the first query message Q.MSG.001 in step 13.02 and preferably selects one or more business records BUS.REC.001-BUS.REC.N in step 13.04 that fit within the specification of the business type BUS.TYPE and the limiting filters CONN.N, TDS.LIMIT and DIST.LIMIT of the first query message Q.MSG.001. In step 13.06 the service provider 4 extracts referral records R.REC.001-R.REC.N from the business records BUS.REC.001-BUS.REC.N, if any, that were previously selected in step 13.04.

The service provider 4 then applies the limiting filters CONN.N, TDS.LIMIT and DIST.LIMIT of the first query message Q.MSG.001 to the extracted referral records R.REC.001-R.REC.N in step 13.08 and applies a ranking algorithm in step 13.10 to rank the extracted referral records R.REC.001-R.REC.N of step 1306 and the business records BUS.REC.001-BUS.REC.N of step 1304. The service provider 4 then forms the first response record RESP.REC.001 and populates the first response record RESP.REC.001 in step 13.12 with the business records BUS.REC.001-BUS.REC.N as ranked in step 13.10.

The service provider 4 next transmits the populated first response record RESP.REC.001 to the client system 8 in step 13.14. The service then proceeds on to step 13.16 and to determine whether to proceed to perform alternate computational operations in step 13.18 or to perform an additional execution of step 13.04.

The following example of a weighting algorithm and selections of weighting factors is meant as a clarifying example only and is limiting the scope of the invented method as claimed. Consider that a first user has set weighting values W1_W3 that are available to the service provider 4 and associated with the first user as follows:

W1: Number of Friends' Recommendations: Highest

W2: Number of All Other Recommendations: Middle

W3: Proximity to User: Lowest Weighting

Based on these settings, the following values are then assigned by the service provider 4 at (a.) a 0.5 weighting value for a Factor 11; (b.) a 0.3 weighting value for a Factor 2; and (c.) a 0.2 weighting factor for a Factor 3.

Next consider a case where the first user searches for a plumber. The business records BUS.REC.001-BUS.REC.N are queried by the service provider 4 and all business records BUS.TYPE.001-BUS.TYPE.N having a business type identifier of PLUMBER and located in the first user's region A-N are returned. For this example, imagine that ten PLUMBER business records BUS.REC.001-BUS.REC.010 are returned.

### Factor 1 Scoring:

The scoring for a Factor 1 is calculated by the service provider 4 selecting the PLUMBER business record BUS.REC.001-BUS.REC.010 with the highest number of Friends' Recommendations. For this example, an exemplary fourth PLUMBER business record BUS.REC.004, has been recommended by 5 of User's Friends. PLUMBER 1 gets the highest Factor 1 score of 0.5 as calculated by the service provider 4.

| Record | Friend's Recommendations | W1/Factor 1 Score |
|---|---|---|
| Plumber 1 | 5 | .5 |

From this data, the service provider 4 calculates the individual Friend's Recommendation value of 0.1 (0.5/5 Friend's Recommendations) to scores all other selected PLUMBER business records BUS.REC.001-BUS.REC.010 in the results set. For each business record BUS.REC.001-BUS.REC.010 in the results set, a calculation is completed by the service provider 4 multiplying the number of Friend's Recommendations by 0.1 to determine each PLUMBER business record's BUS.REC.001-BUS.REC.010 Factor 1 score. It is understood that some business records BUS.REC.001-BUS.REC.010 in the results set may have zero Friend's Recommendations so that the Factor 1 score will be zero as calculated by the service provider. The Factor 1 value for each record in the results set is stored by the service provider 4.

### Factor 1 Scoring:

| Record | Friend's Recommendations | Factor 1 Score |
|---|---|---|
| Plumber 1 | 5 | .5 |
| Plumber 2 | 4 | .4 |
| Plumber 3 | 3 | .3 |
| Plumber 4 | 3 | .3 |
| Plumber 5 | 2 | .2 |
| Plumber 6 | 2 | .2 |
| Plumber 7 | 1 | .1 |
| Plumber 8 | 0 | 0 |
| Plumber 9 | 0 | 0 |
| Plumber 10 | 0 | 0 |

### Factor 2 Scoring:

The same process is then executed by the service provider 4 against the results set to determine Factor 2 scoring. The business record BUS,REC.001-BUS.REC.001 with the highest number of All Other Recommendations is identified and assigned the highest Factor 2 score of 0.3 by the service provider 4.

| Record | All Other Recommendations | Factor 2 Score |
|---|---|---|
| Plumber 5 | 15 | .3 |

From this data, the service provider calculates the individual All Other Recommendation value of 0.02 (0.3/15 All Other Recommendations) to score all PLUMBER business records BUS.REC.001-BUS.REC.010 in the results set. For each record in the results set, a calculation is completed by the service provider 4 multiplying the number of All Other Recommendations by 0.02 to determine that PLUMBER business records' BUS.REC.001-BUS.REC.010 Factor 2 score. It is understood that some PLUMBER business records BUS.REC.001-BUS.REC.010 in the results set may have zero Friend's Recommendations so the Factor 2 score will be zero for these business records. The Factor 2 value for each PLUMBER business record BUS.REC.001-BUS.REC.010 in the results set is stored by the service provider 4.

### Factor 2 Scoring:

| Record | All Other Recommendations | Factor 2 Score |
|---|---|---|
| Plumber 1 | 8 | .16 |
| Plumber 2 | 9 | .18 |
| Plumber 3 | 4 | .08 |
| Plumber 4 | 11 | .22 |
| Plumber 5 | 15 | .3 |
| Plumber 6 | 4 | .08 |
| Plumber 7 | 2 | .04 |
| Plumber 8 | 8 | .16 |
| Plumber 9 | 0 | 0 |
| Plumber 10 | 4 | .08 |

### Factor 3 Scoring:

A similar process is then executed against the results set by the service provider 4 to determine Factor 3 scoring. Utilizing latitude/longitude information for each entity in the results set and the first user's location as determined by GPS, Cellular triangulation, IP Address or other like method, the PLUMBER business record BUS.REC.001-BUS.REC.010 indicating a location BUS.LOC.001-BUS.LOC.010 that is closest to the first user location as determined by the service provider 4 is identified and assigned the highest Factor 3 score of 0.2.

| Record | Proximity to User | Factor 3 Score |
|---|---|---|
| Plumber 1 | .01 Miles | .2 |

From this, the service provider 4 divides the highest Factor 3 score by the number of the PLUMBER business record BUS.REC.001-BIS.REC.N in the results set to determine the increment for assigning a Proximity to User value in a ranked manner (0.2/10=0.02). Each PLUMBER business record BUS.REC.001-BUS.REC.010 in the results set is assigned a number, a multiple of 0.02 based on its place in the ranked list by the service provider 4.

### Factor 3 Scoring:

| Record | Proximity to User | | Factor 3 Score |
|---|---|---|---|
| Plumber 1 | .01 | Miles | .2 |
| Plumber 2 | .02 | Miles | .18 |
| Plumber 3 | .03 | Miles | .16 |
| Plumber 4 | .04 | Miles | .14 |
| Plumber 5 | 1 | Mile | .12 |
| Plumber 6 | 1.5 | Miles | .1 |
| Plumber 7 | 1.7 | Miles | .08 |
| Plumber 8 | 2.3 | Miles | .06 |
| Plumber 9 | 3 | Miles | .04 |
| Plumber 10 | 5.4 | Miles | .02 |

### Summing Factor 1, Factor 2 and Factor 3:

Factor 1, Factor 2 and Factor 3 scores are totaled for all the PLUMBER business record BUS.REC.001-BUS.REC.001 by the service provider 4 in the results set. The results set is then presented to User in order of highest to lowest total score.

| | | | | Total |
|---|---|---|---|---|
| Record | Factor 1 Score | Factor 2 Score | Factor 3 Score | Score |
| Plumber 1 | .5 | .16 | .2 | 0.86 |
| Plumber 2 | .4 | .18 | .18 | 0.76 |
| Plumber 3 | .3 | .08 | .16 | 0.54 |
| Plumber 4 | .3 | .22 | .14 | 0.66 |
| Plumber 5 | .2 | .3 | .12 | 0.62 |
| Plumber 6 | .2 | .08 | .1 | 0.38 |
| Plumber 7 | .1 | .04 | .08 | 0.22 |
| Plumber 8 | 0 | .16 | .06 | 0.22 |
| Plumber 9 | 0 | 0 | .04 | 0.04 |
| Plumber 10 | 0 | .08 | .02 | 0.1 |

### Presenting Triangulated Search Results:

Based on the User's weighting of Factor 1, Factor 2 and Factor 3 as applied by the service provider, and the scoring for each illustrated above, the first user would be presented Search Results for “PLUMBER” displayed in a list sorted in the following order:

| | | | | Total |
|---|---|---|---|---|
| Record | Factor 1 Score | Factor 2 Score | Factor 3 Score | Score |
| Plumber 1 | 0.5 | 0.16 | 0.2 | 0.86 |
| Plumber 2 | 0.4 | 0.18 | 0.18 | 0.76 |
| Plumber 4 | 0.3 | 0.22 | 0.14 | 0.66 |
| Plumber 5 | 0.2 | 0.3 | 0.12 | 0.62 |
| Plumber 3 | 0.3 | 0.08 | 0.16 | 0.54 |
| Plumber 6 | 0.2 | 0.08 | 0.1 | 0.38 |
| Plumber 7 | 0.1 | 0.04 | 0.08 | 0.22 |
| Plumber 8 | 0 | 0.16 | 0.06 | 0.22 |
| Plumber 10 | 0 | 0.08 | 0.02 | 0.1 |
| Plumber 9 | 0 | 0 | 0.04 | 0.04 |

FIG. 14 is a schematic illustration of the first response message RESP.MSG.001 from the social network web server 4 to the first query message Q.MSG.001. The first response message RESP.MSG.001 includes a response message identifier RESP.MSG.ID.001, an identifier of the account ACCT.001 that issued the first query message Q.MSG.001, a network address CLIENT.ADDR of the client system 8 as an addressee address; a network address SERVER.ADDR of the service provider 4 as the sender address; and the query message identifier Q.MSG.ID of the first query message Q.MSG.001 to which the instant first response message RESP.MSG.001 is a reply.

The exemplary first response message RESP.MSG.001 includes information extracted from business records BUS.REC.ID.803, BUS.REC.ID.3057, BUS.REC.ID.N, & BUS.REC.ID.207 in a ranking order R1-RN: BUS.REC.ID.207 that were compiled in response to user query defined in the first query message database record Q.MSG.ID.

Referring now generally to the Figures and particularly to FIG. 15, FIG. 15 is a schematic illustration of the service provider 4 and its hardware and software elements and devices. The service provider 4 comprises a central processing unit 400 that processes all software computations; a networking interface device 402 that enables connectivity with other devices over a computer network, such as the Internet; memory 408 that stores the software code and database records that are used by the service provider 4; and a communication bus device 404 that enables operational connectivity between all devices in the computer system of service provider 4.

The memory 408 stores a number of software elements that are required by the service provider 4. In particular, the memory 408 includes the network system software SW4.1; the social networking platform software SW4.2; a copy of some or all of the client system software CSW; and an operating system software SW4.3.

The memory 408 stores database records that are required by the functions of service provider 4 and by the network system software SW4.1, the social networking platform software SW4.2, and the client system software CSW. In particular the memory 408 stores user account records ACCT.001-ACCT.N; business records BUS.REC.001-BUS.REC.N; query messages records Q.MSG.001-Q.MSG.N; and query response messages records RESP.MSG.001-RESP.MSG.N as long as required, directed or permitted by the social networking platform software SW4.2. The memory 408 further maintains a plurality of distinguishable endorsement lists ELIST.001-ELIST.N. Each endorsement list is a separate listing of referral records R.REC.001-R.REC.N originated via a particular account ACCT.001-ACCT.N, e.g., each referral record R.REC of the first endorsement list ELIST.001 is designated by the service provider 4 and the social network 2 as being originated from the first account ACCT.001 and each referral record R.REC of a second endorsement list ELIST.001 is designated by the service provider 4 and the social network 2 as being originated from a second account ACCT.002.

FIG. 16 is an entity diagram of the social network SN, wherein a plurality of accounts ACCT.001-ACCT.N and business records BUS.REC.001-BUS.REC.N are associated with distinguishable regions REGION A-REGION N. It is understood that the social network SN is instantiated, generated and maintained by the service provider 4, the web server 10 and the plurality of participant systems 6 & 8 acting in concert and sharing, generating accounts, data, messages and records.

The foregoing disclosures and statements are illustrative only of the Present Invention, and are not intended to limit or define the scope of the Present Invention. The above description is intended to be illustrative and not restrictive. Although the examples given herein include many specificities, they are intended as illustrative of only certain possible configurations or aspects of the Present Invention. The examples given should only be interpreted as illustrations of some of the preferred configurations or aspects of the Present Invention and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

What is claimed is:

1. A method of conducting selectively providing access to referral information, comprising:
performing, by a processor executing code stored in memory, the following:
participating in an online community via a first account of the online community, wherein the online community maintains a plurality of user accounts;
populating at least one referral record, the at least one referral record including a vendor identifier and an attribute associated with the vendor identifier, wherein the vendor identifier identifies a vendor;
associating the at least one referral record with the first account; and
establishing a privileged relationship between the first account and at least one other account (“friend account”) of the online community, wherein the friend account is enabled to access the at least one referral record.

2. The method of claim 1, wherein the vendor sells an item selected from a first item group consisting of a good, a service and a license.

3. The method of claim 1, wherein the vendor provides access to an item selected from a first item group consisting of a good, a service and a license.

4. The method of claim 1, wherein the online community comprises a plurality of friend accounts, and each friend account is enabled to access the at least one referral record associated with the first account.

5. The method of claim 1, further comprising populating the at least one referral record with a plurality of attributes.

6. The method of claim 5, wherein at least one attribute includes a textual review of a quality of the vendor.

7. The method of claim 5, wherein at least one attribute includes a textual review of a quantitative indicator of a quality level of the vendor.

8. The method of claim 5, wherein the online community comprises a plurality of friend accounts, and each friend account is enabled to access the at least one referral record of the first account.

9. The method of claim 1, further comprising:
populating a plurality of referral records, each referral record including a vendor identifier and an attribute associated with the vendor identifier, wherein each vendor identifier identifies a vendor; and
associating the plurality of referral records with the first account; and
enabling the friend account to access the plurality of referral records

10. The method of claim 9, further comprising enabling a key word of the plurality of referral records via the friend account.

11. The method of claim 9, further comprising enabling a search by vendor location criteria of the plurality of referral records via the friend account.

12. The method of claim 9, wherein the online community comprises a plurality of friend accounts, and each friend account is enabled to access the plurality of referral records associated with the first account.

13. The method of claim 12, further comprising:
populating a second plurality of referral records, each referral record of the second plurality of referral records including a vendor identifier and an attribute associated with the vendor identifier, wherein each vendor identifier identifies a vendor;
associating the second plurality with the first account; and
enabling selected friend accounts to access the second plurality of referral records.

14. The method of claim 13, further comprising associating the second plurality of referral records with a same vendor aspect.

15. The method of claim 13, further comprising associating the second plurality of referral records with a same attribute comprised within each referral record of the second plurality of referral records.

16. The method of claim 12, further comprising enabling access to at least one referral record associated with at least one friend account via the plurality of friend accounts.

17. A computer-implemented method for delegating access to endorsement lists associated with member accounts of an online community, at least a portion of the method being performed by a server-side computing device comprising at least one processor, the method comprising
a. Associating a first endorsement list with a first member account, the first endorsement list comprising vendor identifiers and vendor information;
b. Granting a second member account accessibility to the first endorsement list; and
c. Denying accessibility to the first endorsement list by all member accounts not expressly authorized by an administrator of the first member account.

18. The method of claim 17, further comprising:
a. Forming a privileged relationship between the second member account and a third member account; and
b. Granting the third member account accessibility to the first endorsement list.

19. The method of claim 18, further comprising:
a. Associating a second endorsement list with a first member account, the first endorsement list comprising additional vendor identifiers and additional vendor information;
b. Denying the second member account accessibility to the second endorsement list.

20. A system comprising:
means to participate in an online community via a first account of the online community, wherein the online community maintains a plurality of user accounts;
means to populate at least one referral record, the at least one referral record including a vendor identifier and an attribute associated with the vendor identifier, wherein the vendor identifier identifies a vendor;
means to associate the at least one referral record with the first account and deny unprivileged access to the at least one referral record by the online community; and
means to establish a privileged relationship between the first account and at least one other account (“friend account”) of the online community, wherein the friend account is enabled to access the at least one referral record.

21. A computer-implemented method comprising:
a. Receiving a plurality of information regarding an entity via an electronically mediated social network, wherein each information is associated with a time indication;
b. Deriving a quality parameter from each information at least partly on the basis of the time indication;
c. Determining a geographic parameter of the entity;
d. Deriving a evaluation result of the entity information at least partly on the basis of the quality indications and the geographic parameter.

22. The method of claim 22, wherein the geographic parameter is derived from a provided location and an entity location associated with the entity.

23. The method of claim 23, wherein the quality parameters are additionally derived partly on the basis of a relationship quality of at least one provider of information associated with the provider.
